(19) United States
(12) Patent Application Publication
(10) Pub. No.: US 2013/0113295 A1
(43) Pub. Date: May 9, 2013

(54) ENERGY HARVESTING SYSTEM AND METHOD

(71) Applicant: Ahmad B. Dowlatabadi, San Jose, CA (US)

(72) Inventor: Ahmad B. Dowlatabadi, San Jose, CA (US)

(73) Assignee: AIVAKA, INC, San Jose, CA (US)

(21) Appl. No.: 13/633,721

(22) Filed: Oct. 2, 2012

Related U.S. Application Data
(60) Provisional application No. 61/542,763, filed on Oct. 3, 2011.

(51) Int. Cl. H02J 1/10

(52) U.S. Cl. CPC H02J 1/10
USPC 307/87

(57) ABSTRACT

An energy harvesting system receives a low power input from an energy harvesting device such as a photovoltaic device or similar, and controls the storage of power in power management logic. The stored power eventually reaches a level that permits it to be supplied to power conversion block for supply of a regulated voltage to a load.

### RELATED APPLICATIONS

This application claims the benefit of U.S. patent application Ser. No. 13/103,808, filed May 9, 2011, and through it U.S. Pat. No. 7,940,033 [application Ser. No. 10/421,254, filed Apr. 22, 2003]; U.S. patent application Ser. No. 61/475,650, filed Apr. 14, 2011 and its conversion application U.S. patent application Ser. No. 13/447,983, filed Apr. 16, 2012; U.S. Patent Application Ser. No. 61/450,915, filed Mar. 9, 2011, and its conversion application, U.S. patent application Ser. No. 13/417,177 filed Mar. 9, 2012; and U.S. Patent Application Ser. No. 61/542,763, filed Oct. 3, 2011, each of which is incorporated herein by reference.

### FIELD OF THE INVENTION

This invention relates generally to the design of a power delivery module for use with an electronic system where the main source of power is energy harvested from the environment and more particularly relates to energy harvesting systems capable of powering devices having low duty cycle.

### BACKGROUND OF THE INVENTION

Wireless electronic sensors are currently operating from primary (disposable, non-rechargeable) batteries. These batteries must be replaced periodically, which can be anywhere from every few hours up to two years or more, depending upon the power consumption of the electronic system.

Ideally, these sensors would be powered solely from energy harvested from the environment, so that the need to replace the batteries would be eliminated. In such an ideal arrangement, energy from ambient light, vibration and motion, heat, RF signals, and electromagnetic waves can be potential sources of energy for these sensors. Photovoltaics convert light to power, but at extremely high cost, and require significant available area compared to the power generated. Likewise, thermoelectric devices and piezo-electric devices have offered various forms of energy conversion, but at high cost and extremely low efficiency. Thus, there has been a long felt need for a system capable of efficiently gathering and converting the energy from the environment, adapting it for storage, and delivering the needed power to the electronic system as needed via voltage regulators.

### THE FIGURES

FIG. 1 illustrates in block diagram form a battery-powered system for powering electronics.

FIG. 2 illustrates in generalized block diagram form an energy harvesting system in accordance with the invention.

FIG. 3 illustrates in greater detail an energy harvesting system in accordance with the invention.

### SUMMARY AND DETAILED DESCRIPTION OF THE INVENTION

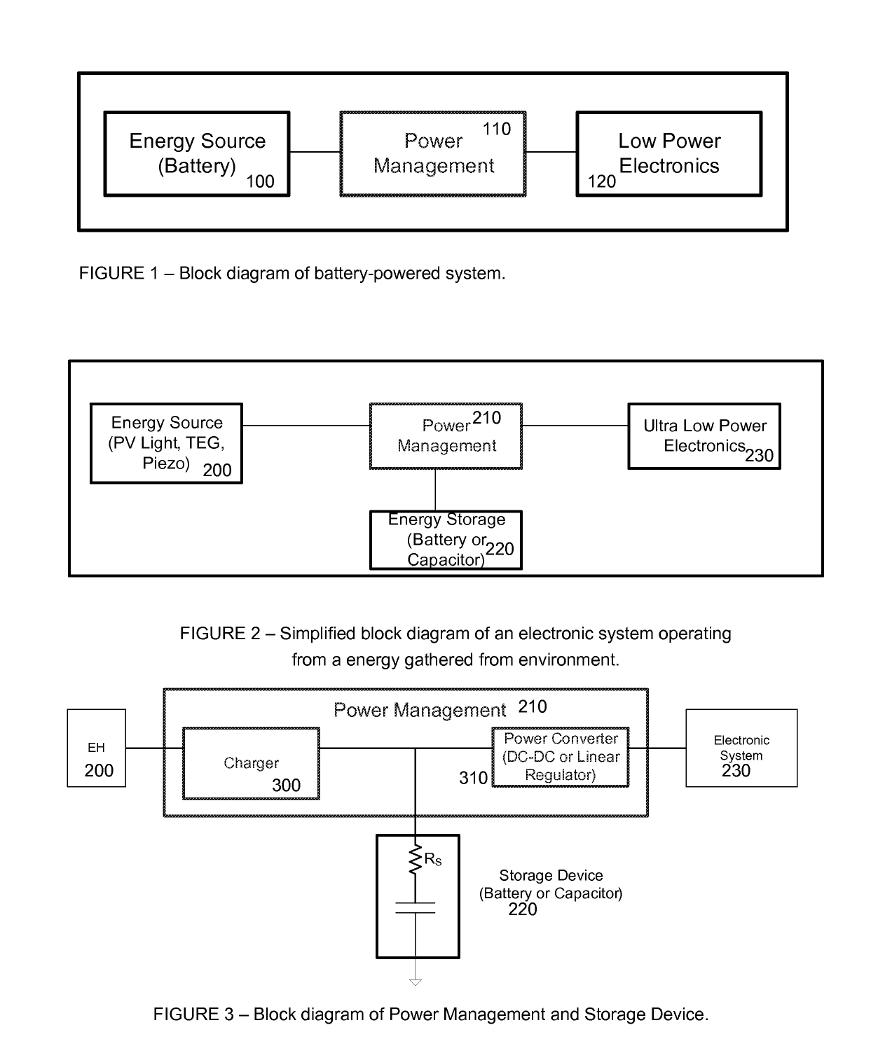

FIG. 1 shows a very simplified block diagram of an electronic system operating from traditional batteries (primary or secondary batteries), where battery 100 supplies power to a power management circuit 110, such as a DC-DC converter, which in turn supplies power to various types of electronics 120.

FIG. 2 shows a basic block diagram of an electronic system powered from harvested energy from the environment (light, heat, motion, RF waves, or Electro-Magnetic waves). An energy harvester 200 provides power to a power management block 210, which enables energy to be stored in one or more storage elements 220, such as an appropriate battery or capacitor, discussed in greater detail hereinafter. The power management block 210 also controls the supply of power to the electronics 230, typically ultra-low-power electronics such as remote sensors.

FIG. 3 illustrates in greater detail the energy harvesting system of the present invention, and in particular shows in greater detail the power management block. As discussed with reference to FIG. 2, the power management block 210 receives an input from the energy harvesting (EH) device 200 which can be a PV cell or a piezo-electric, or a thermoelectric or a RF or EMAG converter. The power management block can be seen in FIG. 3 to comprise two functions: charging, shown at block 300, and power regulation, shown at block 310. The block 300 causes energy supplied by the EH 200 to be stored in the storage device 220. The charger circuit is preferably designed such that it can charge the storage device with maximum possible efficiency. Thus, using a diode is not an optimal solution for such low power applications. The power regulation block 310 then provides a regulated energy source to the load 230. The charging block 300 can be implemented in accordance with the design described in U.S. patent application Ser. No. 13/417,177 filed Mar. 9, 2012, incorporated herein by reference, while the regulation block 310 can be implemented as described in U.S. patent application Ser. No. 13/447,983, filed Apr. 16, 2012, also incorporated herein by reference. The power regulation portion 310 can be DC-DC or linear. A feature of the invention described in application Ser. No. 13/447,983 is that the resistance of the feedback network described there can, in appropriate implementations, be set to a very large value to limit the current load on the DC-DC regulator, and reduce the power consumption. Combined resistor values in the range of 10 Mega-Ohm or larger are practical values for use in this design so the current load due to the feedback resistors is reduced to a very low value. Further details of the DC-DC regulation circuit can be appreciated from U.S. patent application Ser. No. 13/103,808 and its parent, U.S. Pat. No. 7,940,033, both of which are incorporated herein by reference.

The storage element can be nearly anything that can hold charge, for example either a battery or simply a capacitor, but must have a low leakage current to be acceptable for low power operation. If the storage device has a higher leakage current than the current provided by EH device, then the storage device cannot provide sufficient energy when needed.

Another issue with any storage element (capacitor or battery) is its internal resistance. This resistance that is shown as Rₛ in FIG. 3 can create a significant amount of problem in a system if it is not dealt with properly.

A typical electronic sensor 230 operates with a very low duty cycle to conserve energy. For example, it may turn on for 100 ms in a period which can be anywhere from 1 second to maybe 100's of seconds, and stay in deep sleep mode for the rest of the time. During the on-time, the sensor can draw relatively large amount of current. At this point, for example, most Zigbee devices consume roughly around 100 mW of power (30 mA at 3V) and WiFi-based sensors can consume up to 2 A of current at 3V. But, due to the low duty cycle of a sensor, their “average” power consumption is in the range of milliwatts or even microwatts.

So, if the storage device provides a large amount of current, then the power loss in the resistor Rₛ can be significant, not to mention the voltage drop caused by the resistor which can render the regulator useless. Typical thinking is that the current is low, so the value of resistor is not important. It is true that average current into a system is low, but the peak current into the sensor during on-time can be high enough to cause system problems.

If the average current is 1 mA (for a system with 100 mA peak current and 1% duty cycle), then the power loss in the resistor is for a 100-Ohm resistor is 0.1 mW and the voltage drop across the resistor is simply 100 mV. If the battery is charged to 4V, then the voltage drop after the resistor is simply 3.9V if average current is considered in calculations. But, during on-time the peak current can be 100 mA, and the voltage drop across the resistor can be 10V. Consequently, the maximum current out of the battery is limited to 40 mA, and not 100 mA.

To remedy the situation where such a load 230 exists, in some embodiments it is desirable to use a DC-DC converter 310 as shown in FIG. 3 to lower the current drawn from a battery or capacitor.

Having fully described the invention, including various embodiments and alternatives, those skilled in the art will recognize that numerous additional alternatives and equivalents exist which do not vary from the invention. As a result, the scope of the invention is not intended to be limited by the foregoing description or the accompanying figures, but only by the appended claims.

I claim:

1. An energy harvesting system comprising
an input for receiving an input signal from an energy-harvesting device comprising one or more of a group comprising a photo-voltaic cell, a piezo-elecric device, a thermoelectric device, an RF device, and an EMAG converter,
a power management block, that receives the input from the energy-harvesting device, the power management block comprising charging and power regulation,
an energy storage device for receiving charge from the power management block,
and wherein the power regulation comprises a feedback network having a resistance of approximately 10 megohms or more, and
an output for providing a regulated voltage to a load.
